(19) United States
(12) Patent Application Publication
(10) Pub. No.: US 2009/0047021 A1
(43) Pub. Date: Feb. 19, 2009

(54) Integrated overlay card, optical line terminal and system with integrated overlay card, and methods for operating the system and terminal

(75) Inventors: Thomas E. Conklin, Leesburg, VA (US); Timothy J. Doiron, Aurora, IL (US); Marc R. Bernard, Miramar, FL (US); Muneer Zuhdi, Plano, TX (US); Moshe Oron, San Rafael, CA (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 11/889,383

(22) Filed: Aug. 13, 2007

(51) Int. Cl. H04J 14/02

(52) U.S. Cl. 398/79; 398/43

(57) ABSTRACT

An integrated overlay card, an optical line terminal with an integrated overlay card, and a method for operating an optical network. The integrated overlay card may fit at least partially within the optical line terminal. The integrated overlay card includes a wavelength dimension multiplexer/demultiplexer that overlays first signals at a first wavelength onto second signals at a second wavelength, so as to combine signals. The combined signals may be routed to an optical network. In example embodiments, the invention may be used to provide an IP television service.

### BACKGROUND OF THE INVENTION

1. Field of the Invention

The present invention relates generally to an optical network which may be used, for example, to provide video to subscribers. More specifically, the present invention relates to an integrated overlay card, an optical line terminal and system that include an integrated overlay card, and methods for operating an optical network and system.

2. Description of the Related Art

There is a growing demand in the industry to provide voice, data, and video from a headend through a fiber optic network all the way to an individual home or business. Such fiber optic networks are generally referred to as fiber-to-the-home (FTTH), fiber-to-the-premises (FTTP), fiber-to-the-business (FTTB), or fiber-to-the-curb (FTTC) networks, and the like, depending on the specific application of interest. These types of networks are referred to herein as “FTTx networks.” An example of a FTTx network is shown in U.S. Patent Application Pub. No. 2007/0036547, the disclosure of which is hereby incorporated by reference herein in its entirety, as if fully set forth herein.

A passive optical network (PON) is one type of network architecture that is often implemented on a FTTx network. At the headend of a typical PON, an optical line terminal (OLT) with a PON card couples the FTTx network to external services, such as a Public Switched Telephone Network (PSTN) or the Internet. Signals received from such external services and networks are often electrical. In a PON configuration, these electrical signals are converted at the headend into optical signals and are combined onto a single optical fiber. The optical signals are transmitted through the FTTx network to an optical splitter that splits the optical signals from one fiber into many and transmits the signals over a single optical fiber to a number of subscribers' premises. At the subscriber's premises, the optical signals are converted into electrical signals using an Optical Network Termination (ONT). The ONT may split the resultant signals into separate services required by the subscriber, such as computer networking, telephony, and video.

In order to provide a combination of data and video transmissions, a PON may use separate channels in the form of separate wavelengths to transmit downstream video signals, downstream data signals, and upstream data signals. Such a PON configuration using three channels with signals at three wavelengths for data and video signals is advantageous in that it allows for more information to be transmitted through the network, as opposed to configurations including only one or two channels.

Standard OLTs are generally equipped to provide only two channels, that is, a downstream channel at one wavelength and an upstream channel at a second wavelength. A third wavelength carrying a downstream video channel may be added externally to the OLT via an optical coupler. One method of generating the third channel for the PON operating on a FTTx network uses an external Ethernet switch in conjunction with a standard OLT. The Ethernet switch is connected is connected to a video source and provides output of the video content for a given PON on an optical wavelength. External to the OLT and the Ethernet switch, a wave division multiplexer operates to overlay, or combine, the downstream data and video signals, thereby providing a downstream transmission with video signals at one wavelength, and data signals at a second wavelength.

### SUMMARY OF THE INVENTION

The present invention provides various embodiments of an overlay card, a system and an optical line terminal having the card, and methods for operating the system and terminal.

In one example embodiment of the invention, the optical line terminal comprises an interface to connect to at least one external element and an integrated overlay card connected to the interface. The integrated overlay card is adapted to receive first signals from the interface, second signals from the interface, and to overlay the second signals onto the first signals.

In another example embodiment of the invention, the overlay card comprises at least one port through which the overlay card first and second signals are communicated, and a wavelength division multiplexer/demultiplexer that overlays first signals onto second signals. The overlay card fits at least partially within a volume of an optical line terminal.

In yet another example embodiment of the invention, the method comprises multiplexing video and data signals at least partially within the optical line terminal so as to provide the video signals at a first wavelength and the data signals at a second wavelength.

### BRIEF DESCRIPTION OF THE DRAWINGS

FIG. 1 is a block diagram of a FTTx network operating with an OLT according to an example embodiment of the invention.

FIG. 2 is a block diagram of an OLT with an integrated video overlay card according to an example embodiment of the invention, connected to elements 106 and 110 and FTTx network 100 of FIG. 1.

FIG. 3 is a block diagram detailing an integrated video overlay card according to an example embodiment of the invention.

FIG. 4 is a flow chart detailing a method according to an example embodiment of the invention.

### DETAILED DESCRIPTION OF THE INVENTION

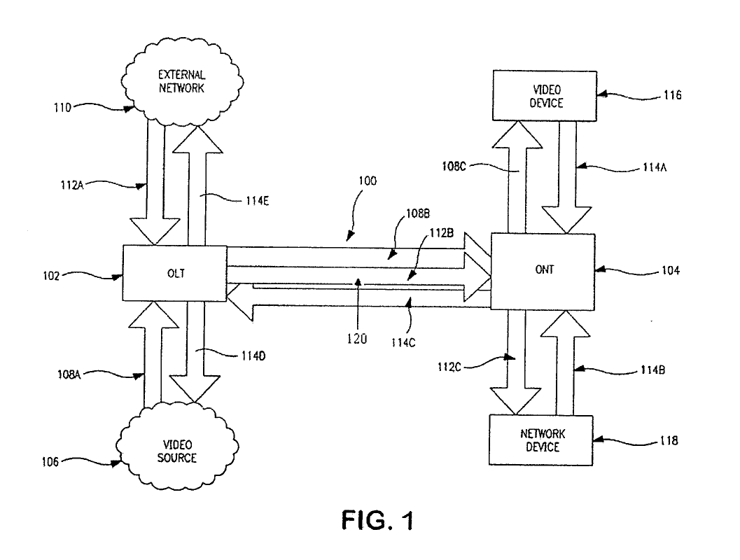

FIG. 1 is a block diagram representing a FTTx network 100 with an optical line terminal (OLT) 102 and an optical network termination (ONT) 104 in accordance with an example embodiment of the present invention. In this embodiment, OLT 102 is part of a passive optical network (PON) architecture implemented on the FTTx network 100.

Using the FTTx network 100, video signals 108A from a video source 106 are routed to a video device 116 at the subscriber's premises. The video signals 108A are overlaid, or combined, with other downstream signals 112A from an external network 110 at the headend with the OLT 102. As will be described more fully below, according to an aspect of the invention an integrated video card associated with the OLT 102 provides the combined transmission 120 of optical video signals 108B at one wavelength overlaid on optical data signals 112B at a second wavelength, for routing the combined transmission 120 on the FTTx network 100 to the subscriber's premises, or otherwise be configured to communicate with devices 116 and 118 at the subscriber's premises. Components 106 and 110 are hereinafter also referred to as “external elements.”

The ONT 104 may be located at a subscriber's premises. The ONT 104 receives the optical video signals 108B, and converts these signals into electrical video signals 108C. The ONT 104 then forwards the electrical video signals 108C to video device 116 for further processing and/or display. The ONT 104 also receives the optical data signals 112B and converts them into electrical network signals 112C, which are forwarded to network device 118. According to an example embodiment of the invention, the ONT 104 receives optical data signals 112B on a different optical wavelength than the optical video signals 108B, and the network device 118 does not receive video traffic other than that which it requests, thereby preventing unnecessary burdens on the operation of the network device 118, although in other embodiment device 118 can receive additional traffic.

The video source 106 connected to the OLT 102 at the headend may be, for example, an RF video source. More specifically, the video source 106 may be a cable television (CATV) headend, video server, or any other type of video signal source that provides video transmissions intended for a subscriber's premises.

The external network 110 connected to the OLT 102 at the headend may include, but is not limited to, a Wide Area Network (WAN), such as a Public Switched Telephone Network (PSTN), the Internet, or a Local Area Network (LAN). Alternatively, any other type of network or external signal source may be used that provides a service such as voice, video, or telephony.

Video device 116 may include, but is not limited to, a Set Top Box (STB) capable of decoding video signals received from the ONT 104 and generating video signals to be used by a video display. Another example of a video device is a general purpose computer having programming instructions that enable the computer to receive the video signals from the ONT 104 and generate video signals for display on a monitor. Other types of video devices may be employed as well.

A network device 118 at the subscriber's premises may include, but is not limited to, a personal computer that a subscriber may wish to couple to a network. As another example, a network device 118 may be a general purpose computing device having programming instructions that allow the general purpose computing device to process the network signals. In addition, a video device, such as a STB, may operate as a network device when communicating non-video data, such as billing and configuration data, with other network devices.

The optical data signals 112B may be used to transmit a variety of types of information, depending on, for example, the type of external network 110 to which the OLT 102 is connected. Examples of such signals 112B that could be transmitted from the external network 110 include telephony signals, video signals, data signals, WAN signals, and Internet signals. These signals 112B are herein referred to as “data signals.” It is understood, however, that the term “data” is not meant to refer to any specific type of information. Further, it is understood that the optical data signals 112B could also include video transmission signals, in addition to the optical video signals 108B being transmitted on the FTTx network 100.

The types and number of video sources 106, external networks 110, video devices 116, and network devices 118 are not limited only to those described above. Similarly, multiple OLTs 102 and ONTs 104 may be used with the FTTx network 100. In other words, various example embodiments of the present invention may be employed in any number of external networks and/or video sources, using more or less than the number of elements depicted in FIG. 1.

To allow for upstream network signals to be transmitted from the subscriber's premises to either the video source 106 or the external network 110, upstream optical signals at a third optical wavelength, different than the wavelengths for the video signals 108B and data signals 112B, are utilized in the FTTx network 100. For example, in embodiment shown in FIG. 1, the video device 116 transmits signals 114A upstream to the ONT 104 at the subscriber's premises. Similarly, the network device 118 transmits signals 114B upstream to the ONT 104. The signals 114A and 114B are combined into upstream optical data signals 114C at the third wavelength by an electrical-to-optical converter in the ONT 104, and are then transmitted to the FTTx network 100. The FTTx network 100 routes the upstream optical data signals 114C to the OLT 102 at the headend. In some example embodiments, the OLT 102 acts as an optical-to-electrical converter and changes the optical signals 114C into electrical signals. At the OLT 102, the upstream signals can be separated into two or more transmissions of signals 114D and 114E based on, for example, routing information included in the upstream optical signals 114C. The two transmissions of signals 114D and 114E may then be routed to the video source 106 and external network 110, selectively, although the signals may be routed to signal destinations 106 or 110, depending on the routing information. An example of the use of such routing information can be found in the aforementioned U.S. Patent Application Pub. No. 2007/0036547.

In accordance with one example embodiment of the invention, the components of the FTTx network 100 operate in accordance with a predetermined multicasting network protocol, such as the Internet Group Management Protocol (IGMP). That is, the video signals are IP video signals that are transmitted using a predetermined multicasting protocol, wherein the video signals are assigned to separate video subchannels. Each ONT 104, coupled to the FTTP network 100 receives all of the multicast video signal channels. To determine which video channel should be forwarded to the video device 116, the ONT 104 monitors, or “snoops”, on the content of the multicast video signals and routes to the video device 116 only those signals that belong to a video subchannel preselected by the video device 116. In some example embodiments, the upstream optical data signals 114C can be used to support channel change and video on demand controls. Thus, only channels that are actually being viewed would be streamed in the downstream video signals 108B, thereby reducing the load on the network. Examples of the use of such multicast channels, channel change, and video on demand controls can be found in the aforementioned U.S. Patent Application Pub. No. 2007/0036547.

In an example embodiment of the invention, the wavelength for the optical video signals 108B is 1550 nm, the wavelength for the downstream optical data signals 112B is 1490 nm, and the wavelength for the upstream data signals 114C is 1310 nm. Alternatively, others wavelengths may be used for any of the optical signals. In further alternatives, more than one signal may be carried on a signal wavelength.

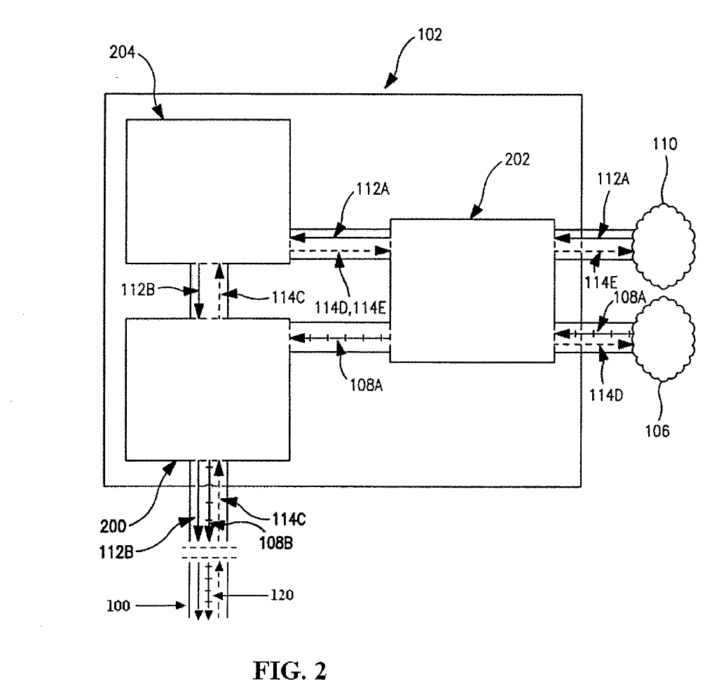

FIG. 2 is a block diagram of an OLT 102 that includes an integrated overlay card 200 in accordance with an example embodiment of the invention connected to external elements 106 and 110. In the embodiment depicted in FIG. 2, the integrated overlay 200 is used to overlay video signals onto data signals, as will be described below. Therefore, the integrated overlay 200 will hereinafter be referred to an “integrated video overlay card.” It will be recognized, however, that in other embodiments the integrated overlay card 200 could be used to overlay signals other than video signals. For example, in some embodiments the integrated overlay card could be used to overlay data and/or telephony signals onto other signals.

The OLT 102 includes an interface 202 through which the OLT 102 may be connected to the external network 110 and the video source 106. The interface 202 may be, for example, an Ethernet network termination card or the like. In example embodiments, the interface 202 will have one or more ports accepting connectors linked to other structures in the OLT 102, as well as one or more ports accepting connectors linked to external elements. Other types of interfaces may also be used that are capable routing signals to and from the OLT 102. As described above, the external network 110 may provide to the OLT 102 data signals 112A, and the video source 106 may provide video signals 108A. Also, the OLT 102 can provide upstream signals 114D and 114E through the interface 202 for uploading to the video source 106 and/or to the external network 110. In example embodiments, the video signals 108A, data signals 112A and upstream data signals 114D and 114E are electrical signals, although in other embodiments these signals may have other formats. In the case of electrical signals, PON card 204 and the integrated video overlay card 200 in the OLT 102 function as electrical-to-optical converters changing the electrical signals from the video source 106 and from the external network 110 into optical signals for transmission on the FTTx network 100, and the PON card 204 functions as an optical-to-electrical converter changing the upstream optical data signals 114C into electrical signals 114D and 114E for uploading to the video source 106 and/or external network 110.

In the embodiment depicted in FIG. 1, the interface 202 routes the signals 112A from the external network 110 to a PON card 204. The interface 202 also operates to route the video signals 108A from the video source 106 to the integrated video overlay card 200. The interface 202 still further operates to route the upstream signals 114D and 114E from the OLT 102 to the video source 106 and/or the external network 110.

The PON card 204 functions to implement a PON architecture for use with the FTTx network 100. In some example embodiments, the PON card 204 may originate a Broadband PON (BPON) or Gigabit PON (GPON) for use on the FTTx network 100. Other types of PONs may be implemented as well.

In example embodiments, the PON card 204 includes an electrical-to-optical converter that generates the initial PON optical signals by changing electrical data signals 112A received from the external network 110 into optical data signals 112B. The PON card 204 may also include an optical-to-electrical converter for changing upstream optical data signals 114C routed from the integrated video overlay card 200 into upstream electrical data signals 114D and 114E. The PON card 204 may provide bandwith allocation for different subscribers, traffic policing, grooming, prioritization, network time distribution, and upgrade services for equipment at the customer's premise.

It should be noted that although the OLT 102 shown in FIG. 2 includes one network interface 202, one PON card 204, and one integrated video overlay card 200, the OLT 102 may have multiple interfaces and cards. Further, FIG. 2 is not meant to indicate a particular spatial relationship between the elements, as many different arrangements and relative spatial relationships of these elements within the OLT 102 are possible. It should also be noted that while the elements are shown in FIG. 2 as fitting completely within the OLT 102, the elements may also at least partially extend beyond the outer frame of the OLT 102, while still being associated with the OLT 102.

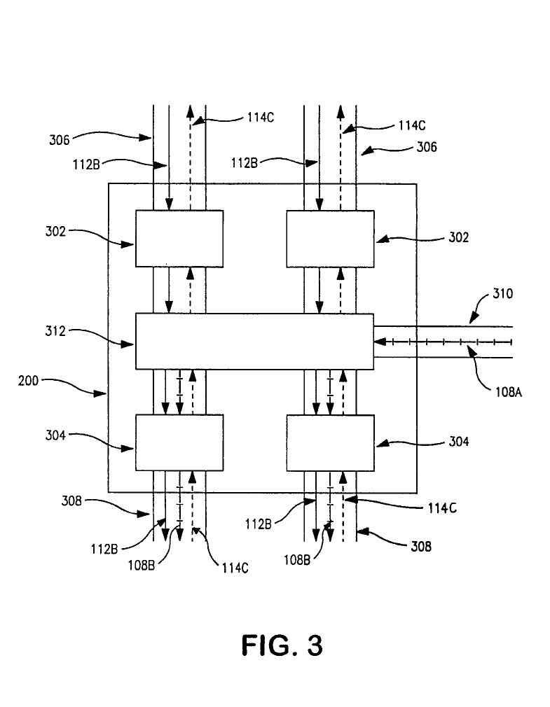

FIG. 3 is a block diagram of the integrated video overlay card 200 according to an example embodiment of the invention. While the video overlay card 200 is referred to herein as a “card,” the device could take on a variety of shapes and sizes. The term “card,” therefore, is not intended to connotate any particular structure. In this respect, the video overlay card 200, as well as the OLT 102 may be correspondingly designed to allow any desired association between the two structures. For example, the OLT 102 may be enlarged or modified in structure to support the integrated video overlay card 200, if appropriate. As another example, the integrated video overlay card 200 could be sized and shaped to fit in an open space within an existing OLT.

The integrated video overlay card 200 includes ingress ports 302 for connecting the integrated video overlay card 200 to the PON card 204. Although two ingress ports 302 are shown in FIG. 3, the integrated video overlay card could include only one ingress port. Alternatively, the integrated video overlay card could include more than two ingress ports. In some example embodiments, the number of ingress ports equals the number of ports on the PON card to which the video overlay card is connected.

Connectors 306 compatible with the ingress ports 302 and the PON card 204 provide a connection between the PON card 204 and the integrated video overlay card 200. The connectors 306 route optical signals between the PON card 202 and the integrated video overlay card 200. That is, connectors 306 route the optical data signals 112B from the PON card 202 to the integrated video overlay card 200. Further, the connectors 306 route the upstream optical data signals 114C from the integrated video overlay card 200 to the PON card 202.

In some example embodiments, the ingress ports 302 may be single mode fiber optic ports, such as SC/PC. In such a case, the connectors 306 include single mode fiber optic jumpers, with each fiber optic jumper being connected at one of its ends to the PON card 204, and being connected at the other of its ends to an ingress port 302. Other types of ingress ports 302 and compatible connectors 306 may be used as well.

The integrated video overlay card 200 further includes egress ports 304. Although two egress ports 304 are shown in FIG. 2, the integrated video overlay card 200 may include only one egress port. Alternatively, the integrated video overlay card may include more than two egress ports. In example embodiments such as that shown in FIG. 3, the number of egress ports is equal to the number of ingress ports, although their numbers may also differ.

As is apparent from the above description, the terms “ingress” and “egress” used to describe ports 302 and 304 on the video overlay card 200 are intended to signify the general orientation of the ports relative to the OLT 102, with the “ingress” ports 302 being for connection to devices within the OLT 102 such as the PON card 204, and the “egress” ports 304 for connection to external elements such as the FTTx network 100. As is also apparent from the above description, both ingress ports 302 and egress ports 304 are bi-directional in that signals may travel into and out of the ports, although in other embodiments unidirectional ports may be used.

Connectors 308 compatible with the egress ports 304 are used to provide the connection between the integrated video overlay card 200 and the FTTx network 100. The connectors 308 route optical video signals 108B and optical data signals 112B from the integrated video overlay card 200 to the FTTx network 100. At the same time, the connectors 308 route the upstream optical data signals 114C from the FTTx network 100 to the integrated video overlay card 200.

In some embodiments, the egress ports 304 may be single mode fiber optic ports, such as SC/PC. In such a case, single mode fiber optic jumpers may be used as the connectors 308. Other types of egress ports 304 and compatible connectors 308 may be used as well.

The integrated video overlay card 200 is also connected to the interface 202 using one or more connectors 310. The connectors 310 route the video signals 108A from the interface 202 (FIG. 2) to the integrated video overlay card 200. The connectors 310 could also be used to route signals from the integrated video overlay card 200 to the interface 202. In example embodiments, the connectors 310 may be in the form of serializer/deserializer (SerDes) chips. Other types of connectors 310 may be used as well.

The integrated video overlay card 200 may also be interfaced with additional elements. For example, the integrated video overlay card 200 may be interfaced to an element management system (EMS), thereby allowing the EMS to manage and monitor the integrated video overlay card 200 in the manner as described herein. That is, the EMS may have a processor and memory for storing programs to enables operation of the integrated video overlay card 200, as well as other network devices.

The integrated video overlay card 200 includes a multiplexer/demultiplexer 312, according to an example embodiment of the invention. In some example embodiments, the multiplexer/demultiplexer 312 may be a wavelength division multiplexer/demultiplexer, although in other embodiments other multiplexer/demultiplexer devices can be used as well. The multiplexer/demultiplexer 312 receives the optical data signals 112B routed from the ingress ports 302, and also receives the video signals 108A routed to the integrated video overlay card 200 from the interface 202. In cases where the video signals 108A are electrical, the multiplexer/demultiplexer 312 operates as an electrical-to-optical converter changing the electrical video signals 108A into optical video signals 108B at preassigned wavelengths. This preassigned wavelengths for the optical video signals 108A is different then the wavelengths of the optical data signals 112B which are received from the PON card 204, in an example embodiment of the invention. In other embodiments, a separate electrical-to-optical converter and/or plural electrical-to-optical converters may be used in conjunction with the multiplexer/demultiplexer 312.

The multiplexer/demultiplexer 312 transparently overlays, or combines, the optical video signals 108B onto the optical data signals 112B. As a result, a combined transmission 120 (FIGS. 1 and 2), including the optical video signals 108B at one wavelength, and the optical data signals 112B at a different wavelength, is generated by the integrated video card 200 associated with the OLT 102.

As explained above, in example embodiments, the wavelength of the optical video signals 108B generated by multiplexer/demultiplexer 312 can be 1550 nm, and the optical video signals 108B can be overlaid on the optical data signals with a wavelength of 1490 nm. However, other wavelengths can be used for the optical video and data signals.

By providing different wavelengths for data and video transmission, the integrated video overlay card 200 allows for expanded overall traffic carrying and output capability/capacity to the FTTx network 100. For example, the video wavelength added by multiplexer/demultiplexer 312 may carry up to 2.5 Gbps of unidirectional Ethernet traffic. Also, the integrated video overlay card 200 may fit substantially, if not completely, within the OLT 102. Thus, no additional devices are needed in order to overlay the optical video signals 108B onto the optical data signals 112B, and, accordingly, no additional space is needed adjacent to the OLT 102 at the headend for any such additional devices. Accordingly, external connectors between the OLT 102 and additional devices are not needed, thereby simplifying the overall setup at the headend, and eliminating sources of network degradation.

The optical video signals 108B provided by OLT 102 for transmission on the FTTx network 100 may be used for different applications. In example embodiments, the optical video signals 108B may be used to provide IP television services to subscribers with the network configuration, as is generally described above. In such a case, the integrated video overlay card 200 used with the OLT 102 allows for easy migration from RF based video to IP based video transmission by eliminating the need for connection between an OLT and additional external devices for overlaying the video signals onto the optical signals.

The video overlay card 200 may be associated with the OLT 102 in any manner, so long as connections can be made between the video overlay card 200 and the PON card 204, the interface 202, and the FTTx network 100. For example, the video overlay card 200 could be attached to the internal structure of the OLT 102 by first opening a portion of the outer frame of the OLT 102, and then selecting a specific position for placement of the integrated video overlay card 200 within OLT 102. As a further example, the video overlay card 200 could be attached to the outer frame of the OLT 102. As yet another example, the outer frame of the OLT 102 could be modified to partially or fully support the integrated video overlay card 200, such as through the addition of slots in outer frame of the OLT 102. Many other associations between the OLT 102 and the video overlay card 200 are also possible.

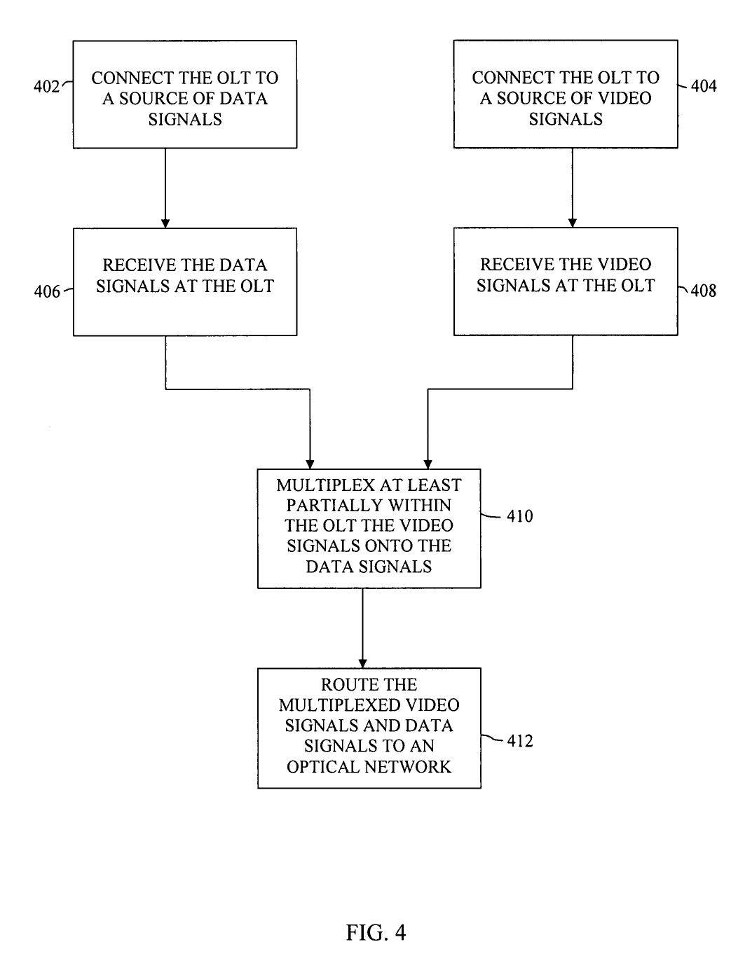

FIG. 4 is a flow chart detailing a method according to an example embodiment of the invention. The method according to the invention may utilize some, or all of the features and devices described above. In block 402, an OLT is connected to a source of data signals, and in block 404, the OLT is connected to a source of video signals. The OLT may thereby receive data signals and video signals in blocks 406 and 408, respectively. At block 410, the video signals are multiplexed onto the data signals at least partially within the OLT, thereby providing the video signals and optical signals at different wavelengths. Finally, at block 412, the multiplexed video and data signals are routed to an optical network.

It should be noted that additional features of the method may take place beyond those shown in FIG. 4, such as the features outlined in the above-described embodiments. Further, methods according to the invention are not necessarily limited to any particular order. That is, the features of a method according to the invention could take place in a variety of orders other than an order that may be inferred from FIG. 4.

It should also be noted that while the above-described embodiments are described in conjunction with an OLT, the invention is not necessarily limited to be used with an OLT. That is, the invention could be used in other embodiments with other fiber optic network devices. For example, in some embodiments the invention could be used with an optical network terminal (ONT), a remote terminal (RT), a network terminal (NT), and the like.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. An optical line terminal, comprising:
an interface to connect to at least one external element; and
an integrated overlay card connected to the interface, the integrated overlay card adapted to receive first signals from the interface, second signals from the interface, and to overlay the second signals onto the first signals.

2. An optical line terminal as set forth in claim 1, wherein the integrated overlay card comprises at least one ingress port and at least one egress port through which the signals are communicated.

3. An optical line terminal as set forth in claim 2, wherein the at least one ingress port and the at least one egress port are single mode fiber optic ports.

4. An optical line terminal as set forth in claim 1, further comprising a passive optical network card connected to the interface and the integrated overlay card.

5. An optical line terminal as set forth in claim 4, wherein the integrated overlay card is connected to the passive optical network card via at least one single mode fiber optic jumper.

6. An optical line terminal as set forth in claim 1, wherein the integrated overlay card is connected to the interface by at least one serializer/deserializer chip.

7. An optical line terminal as set forth in claim 1, wherein the first signals are data signals and the second signals are video signals.

8. An optical line terminal as set forth in claim 1, wherein the integrated overlay card is disposed within a volume of the optical line terminal.

9. An optical line terminal as set forth in claim 1, wherein the integrated overlay card comprises a wavelength division multiplexer/demultiplexer that overlays the first signals at a wavelength different than the wavelength of the second data signals.

10. An overlay card, comprising:
at least one port through which the overlay card first and second signals are communicated; and
a wavelength division multiplexer/demultiplexer that overlays first signals onto second signals,
wherein the overlay card fits at least partially within a volume of an optical line terminal.

11. An overlay card as set forth in claim 10, wherein the at least one port comprises a plurality of ingress ports and a plurality of egress ports.

12. An overlay card as set forth in claim 10, wherein the at least one port is a single mode fiber optic port.

13. An overlay card as set forth in claim 10, wherein overlay card fits entirely within a volume of the optical line terminal.

14. An overlay card as set forth in claim 10, wherein the wavelength division multiplexer/demultiplexer overlays the first signals at a wavelength different than the wavelength of the second signals.

15. An overlay card as set forth in claim 10, wherein the first signals are video signals and the second signals are data signals.

16. A method of operating network element, the method comprising:
multiplexing video and data signals at least partially within an optical line terminal so as to provide the video signals at a first wavelength and the data signals at a second wavelength.

17. A method as set forth in claim 16, wherein the first wavelength is 1550 nm and the second wavelength is 1490 nm.

18. A method as set forth in claim 16, further comprising:
providing optical signals to the optical line terminal from the optical network, the optical signals from an optical network being provided to the optical line terminal at a third wavelength.

19. A method as set forth in claim 18, wherein the third wavelength is 1310 nm.

20. A method as set forth in claim 16, wherein the video signals include multicast video channels.

21. A method as set forth in claim 20, further comprising:
providing upstream optical signals to the optical line terminal from an optical network for uploading to the source of data signals or the source of video signals,
wherein the optical signals from the optical network include routing information.

22. A method as set forth in claim 21, wherein the upstream optical signals include channel change and video on demand controls for use in providing an IP television service.

23. A method as set forth in claim 16, wherein the video signals carry up to 2.5 Gbps of Ethernet traffic.

24. A method as set forth in claim 16, wherein the video and data signals are routed to an optical network.
